(19) United States
(12) Patent Application Publication
(10) Pub. No.: US 2018/0093446 A1
(43) Pub. Date: Apr. 5, 2018

(54) NON-CRIMP FABRIC AND METHOD OF MANUFACTURING

(71) Applicant: The Boeing Company, Chicago, IL (US)

(72) Inventor: Amol Ogale, Munich (DE)

(21) Appl. No.: 15/281,525

(22) Filed: Sep. 30, 2016

(51) Int. Cl. B32B 5/06; B32B 5/02; B32B 5/12; B32B 5/26; D04H 1/498

(52) U.S. Cl. CPC B32B 5/06; B32B 5/022; B32B 5/12; B32B 5/26; D04H 1/498; B32B 2262/106; D10B 2505/12; B32B 2262/0269; B32B 2262/0253; B32B 2260/023; B32B 2260/046; B32B 2307/718; B32B 2605/18; B32B 2262/101

(57) ABSTRACT

A non-crimp fabric includes a non-crimp layup of one or more non-crimp layers, each one of the non-crimp layers is formed of tows arranged parallel to each other, a nonwoven fabric that includes a nonwoven fabric layer engaged to an outer non-crimp layer of the non-crimp layup, the nonwoven fabric layer is formed of fibers, wherein a portion of the fibers extend at least partially though the non-crimp layup to hold the non-crimp layers and the nonwoven fabric layer together.

### FIELD

The present disclosure is generally related to composites and, more particularly, to non-crimp fabrics used as reinforcing layers to form composite laminates and, still more particularly, to non-crimp fabrics formed from non-crimp layers held together by an integrated nonwoven fabric layer.

### BACKGROUND

Composite are widely used in a variety of applications as high-strength and low-weight materials, for example, to replace metals. As one example, composites are used in increasing quantities in aerospace applications due to their high strength-to-weight ratios, corrosion resistance and other favorable properties.

Generally, a composite laminate is formed from one or more layers of reinforcing fibers infused with a matrix material (e.g., a resin). As an example, laminates can be formed of multiple layers or plies of resin pre-impregnated fibers, known as a prepreg. Alternatively, laminates can also be formed of multiple layers of dry fibers, known as a preform or dry fiber layup, which are subsequently infused with a matrix material to create the final composite part. The reinforcing fibers of a preform are formed by laying up several reinforcement layers into a stack of a predetermined thickness. The reinforcing layers may be unidirectional or, more typically, multiaxial. As used herein, the term “unidirectional” means that the reinforcing fibers of all of the reinforcing layers are arranged in a single orientation or direction. As used herein, the term “multiaxial” means that the reinforcing fibers of alternating ones of the reinforcement layers are arranged in different orientations or directions to produce a reinforcing fabric with optimum strength and stiffness in one or more directions.

Additionally, the reinforcing fibers may be a woven fabric or a non-crimp fabric. As used herein, the term “woven fabric” has its ordinary meaning as known to those skilled in the art and may include fabrics where multiple layers of continuous fibers, or filaments, are interlaced at 0° (e.g., the warp direction) and 90° (e.g., the weft direction) to form a woven fabric. As used here, the term “non-crimp fabric” has its ordinary meaning as known to those skilled in the art and may include fabrics where multiple layers of continuous fibers, or filaments, are laid upon each other (e.g., stacked) and transformed into a fabric by stitching or application of a binder, such that the filaments remain straight and without a substantial crimp.

Traditional non-crimp fabrics offer several performance advantages relative to woven fabrics. Additionally, non-crimp fabrics may be cheaper to produce and faster to manufacture. The primary role of the stitching is to hold the layers of the non-crimp fabric together. Typically, the stitching is formed from a thin thermoplastic polymer (e.g., polyester) thread or yarn.

However, the use of stitching and/or a binder introduces external foreign material into the non-crimp fabric. Introduction of foreign material into the non-crimp fabric may create problems in the final composite made using the non-crimp fabric that is held together with the stitching and/or binder. As an example, as the thickness (e.g., the number of layers) of the non-crimp fabric increases, the ability to conform to changes in the shape of the component being made from the reinforcing fabric (e.g., drapability of the reinforcing fabric) decreases due to restrictions imposed by the stitching or the binding material. As another example, the material used for the stitching may be incompatible with the infused matrix material. As yet another example, the stitching process may create permanent holes in the reinforcing fabric that may create resin rich zones within the reinforcing fabric during infusion and/or cause localized resin shrinkage.

Accordingly, those skilled in the art continue with research and development efforts in the field of composite laminates and, more particularly, in the field of non-crimp reinforcing fabrics.

### SUMMARY

In one embodiment, the disclosed non-crimp fabric includes a non-crimp layup of non-crimp layers, each one of the non-crimp layers being formed of tows of reinforcement material arranged parallel to each other, and a nonwoven fabric integrated through the non-crimp layup to hold the non-crimp layers and the nonwoven fabric together.

In another embodiment, the disclosed composite structure includes non-crimp layers of a non-crimp fabric, wherein each non-crimp layer of the non-crimp fabric includes a non-crimp layup of non-crimp layers, and a nonwoven fabric integrated through the non-crimp layup to hold the non-crimp layers and the nonwoven fabric together, and a matrix material infused through the non-crimp layers of the non-crimp fabric to hold the non-crimp layers together.

In yet another embodiment, the disclosed method for making a non-crimp fabric includes the steps of: (1) forming a non-crimp layup, (2) forming a nonwoven fabric, and integrating the nonwoven fabric with the non-crimp layup to hold the non-crimp layup and the non-woven fabric together.

Other embodiments of the disclosed apparatus and method will become apparent from the following detailed description, the accompanying drawings and the appended claims.

### BRIEF DESCRIPTION OF THE DRAWINGS

FIG. 1 is a schematic block diagram of one embodiment of the disclosed non-crimp fabric;

FIG. 2 is a schematic cutaway perspective view of one embodiment of the non-crimp layup;

FIG. 3A is a schematic partial cross-sectional view of one embodiment of the nonwoven fabric;

FIG. 3B is a schematic partial top plan view of the nonwoven fabric shown in FIG. 3A;

FIG. 4A is a schematic partial cross-sectional view of another embodiment of the nonwoven fabric;

FIG. 4B is a schematic partial top plan view of the nonwoven fabric shown in FIG. 4A;

FIG. 5 is a schematic partial cross-sectional view of another embodiment of the disclosed non-crimp fabric;

FIG. 6 is a schematic partial cross-sectional view of yet another embodiment of the disclosed non-crimp fabric;

FIG. 7 is a schematic illustration of one embodiment of the manufacturing apparatus used to make the non-crimp fabric;

FIG. 8 is a schematic illustration of another embodiment of the manufacturing apparatus used to make the non-crimp fabric;

FIG. 9 is a schematic block diagram of one embodiment of the composite structure made using the disclosed non-crimp fabric;

FIG. 10 is a schematic cross-sectional view of another embodiment of the composite structure;

FIG. 11 is a flow diagram of one embodiment of the disclosed method for making the non-crimp fabric;

FIG. 12 is a schematic illustration of an aircraft; and

FIG. 13 is a schematic block diagram of aircraft production and service methodology.

### DETAILED DESCRIPTION

The following detailed description refers to the accompanying drawings, which illustrate specific embodiments and/or examples described by the disclosure. Other embodiments and/or examples having different structures and operations do not depart from the scope of the present disclosure. Like reference numerals may refer to the same feature, element or component in the different drawings.

Illustrative, non-exhaustive embodiments, which may be, but are not necessarily, claimed, of the subject matter according the present disclosure are provided below.

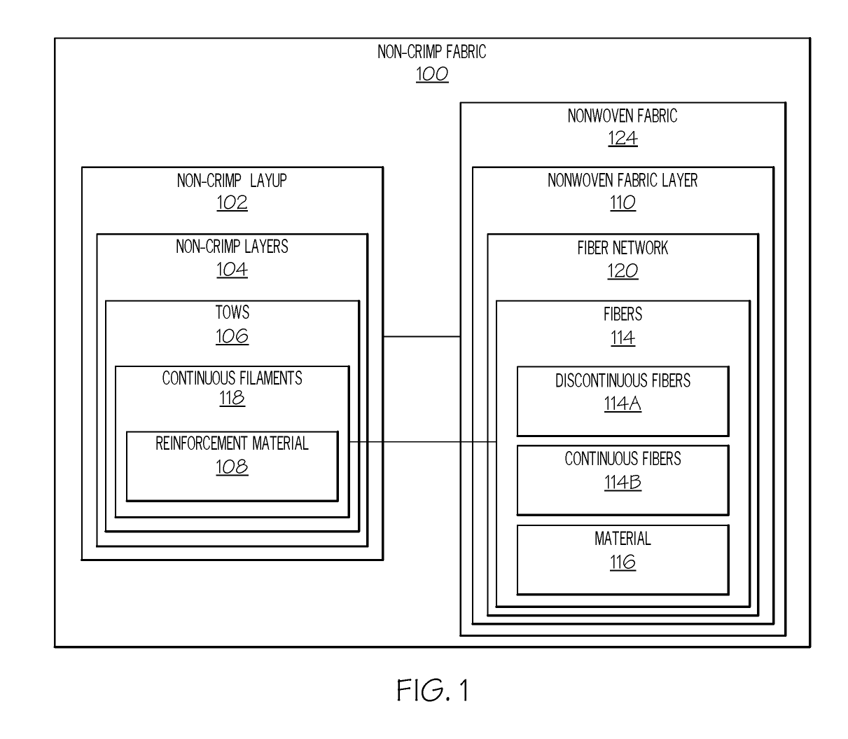

FIG. 1 is a schematic block diagram illustrating one embodiment of the disclosed non-crimp fabric 100. In the illustrative embodiment, the non-crimp fabric 100 includes a non-crimp layup 102 and a nonwoven fabric 124. The nonwoven fabric 124 is disposed on an outer surface of the non-crimp layup 102. The nonwoven fabric 124 is integrated through the non-crimp layup 102 to hold the non-crimp layup 102 and the nonwoven fabric 124 (e.g., the non-crimp fabric 100) together. Thus, as used herein, the term “non-crimp fabric” includes fabrics where one or more non-crimp layers 104 of continuous filaments 118 are laid upon each other (e.g., stacked) and transformed into a fabric by integrating the nonwoven fabric 124 with the non-crimp layup 102, such that the continuous filaments 118 remain straight and without a substantial crimp.

In the illustrative embodiment, the non-crimp layup 102 includes or is formed from non-crimp layers 104. Each one of the non-crimp layers 104 includes or is formed from tows 106. As used herein, the term “tow” has its ordinary meaning as known to those skilled in the art and may include or is formed from an untwisted bundle of continuous filaments 118. The tows 106 are made of a reinforcement material 108. The tows 106 may also be referred to as multifilament tows or multifilament yarns. As used herein, the term “filament” has its ordinary meaning as known to those skilled in the art and may include one or more fibrous materials adapted for the non-crimp layer 104 for reinforcement of composites. The continuous filaments 118 are made of the reinforcement material 108.

In an example embodiment, the tows 106 forming each non-crimp layer 104 are arranged parallel to each other in a single orientation or direction. Thus, the orientation or direction of the non-crimp layer 104 may be defined by the orientation or direction of the tows 106. As an example, the tows 106 are spread apart and positioned relative to each other to form a sheet of the continuous filaments 118 arranged in a single orientation or direction to form each non-crimp layer 104.

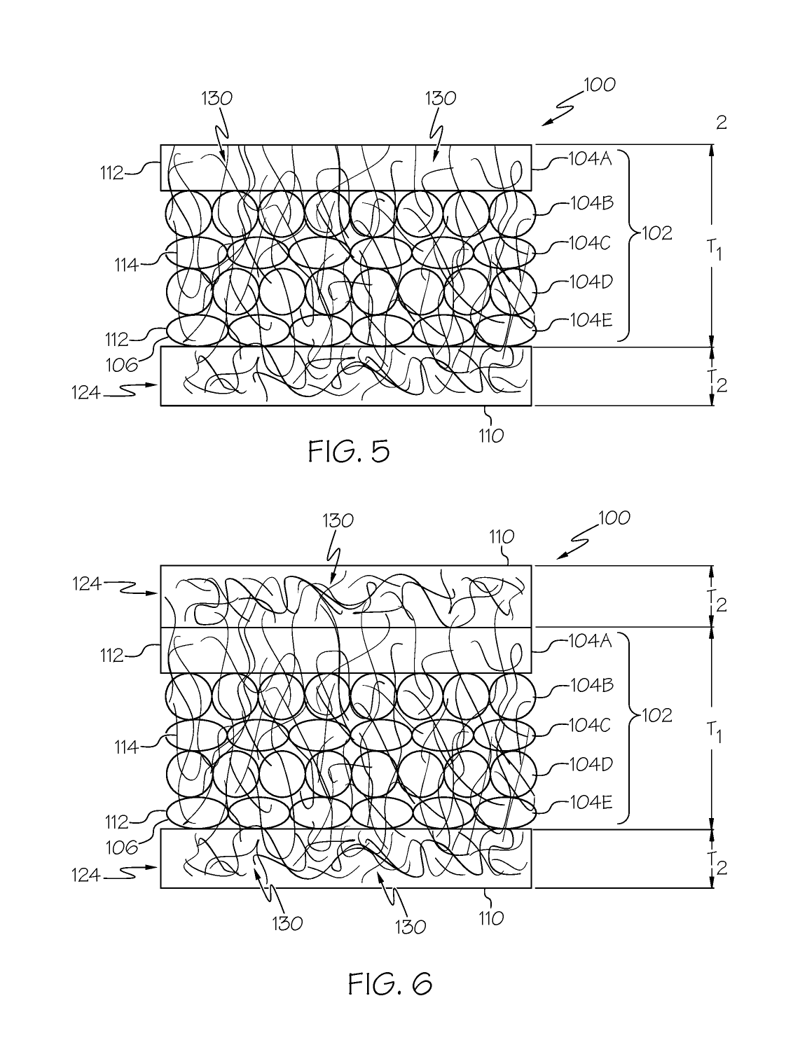

In the illustrative embodiment, the nonwoven fabric 124 includes or is formed from a nonwoven fabric layer 110, which may also be referred to as a nonwoven fiber layer. The nonwoven fabric layer 110 is engaged to an outer non-crimp layer 112 (FIGS. 5 and 6) of the non-crimp layup 102. The nonwoven fabric layer 110 includes or is formed from fibers 114. As used herein, the term “fiber” has its ordinary meaning as known to those skilled in the art and may include one or more fibrous materials adapted for the nonwoven fabric layer 110. A portion of the fibers 114 extend at least partially through the non-crimp layup 102 to hold the non-crimp layers 104 and the nonwoven fabric layer 110 together.

The non-crimp layup 102 may include any number (e.g., a plurality) of non-crimp layers 104. As an example, the non-crimp layup 102 may include two or more non-crimp layers 104 arranged in a single orientation or direction to form a unidirectional non-crimp layup 102 and, thus, a unidirectional non-crimp fabric 100. As another example, the non-crimp layup 102 may include two or more non-crimp layers 104 arranged in different orientations or directions to form a multiaxial non-crimp layup 102 and, thus, a multiaxial non-crimp fabric 100.

In a specific example, the non-crimp layup 102 includes two non-crimp layers 104 to form a biaxial non-crimp fabric (NCF). In another specific example, the non-crimp layup 102 includes three non-crimp layers 104 to form a triaxial (NCF). In yet another specific example, the non-crimp layup 102 includes four non-crimp layers 104 to form a quadraxial (NCF). In other examples, the non-crimp layup 102 includes more than four non-crimp layers 104.

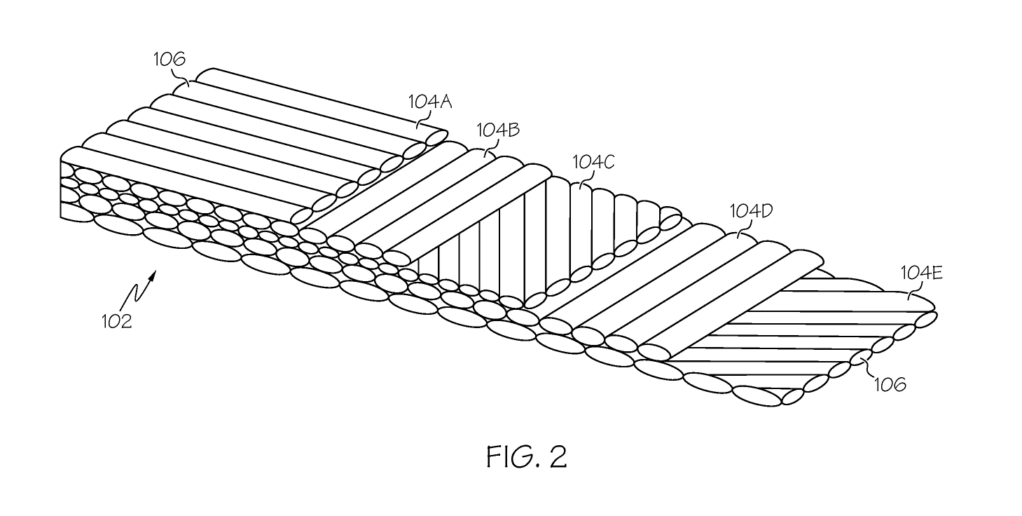

FIG. 2 is a schematic cutaway view of one embodiment of the non-crimp layup 102. The non-crimp layup 102 is constructed from a stack or laminate of superimposed non-crimp layers 104. The non-crimp layers 104 may also referred to as plies or lamina. In the illustrative embodiment, the non-crimp layup 102 includes five non-crimp layers 104, identified as a first non-crimp layer 104A, a second non-crimp layer 104B, a third non-crimp layer 104C, a fourth non-crimp layer 104D and a fifth non-crimp layer 104E.

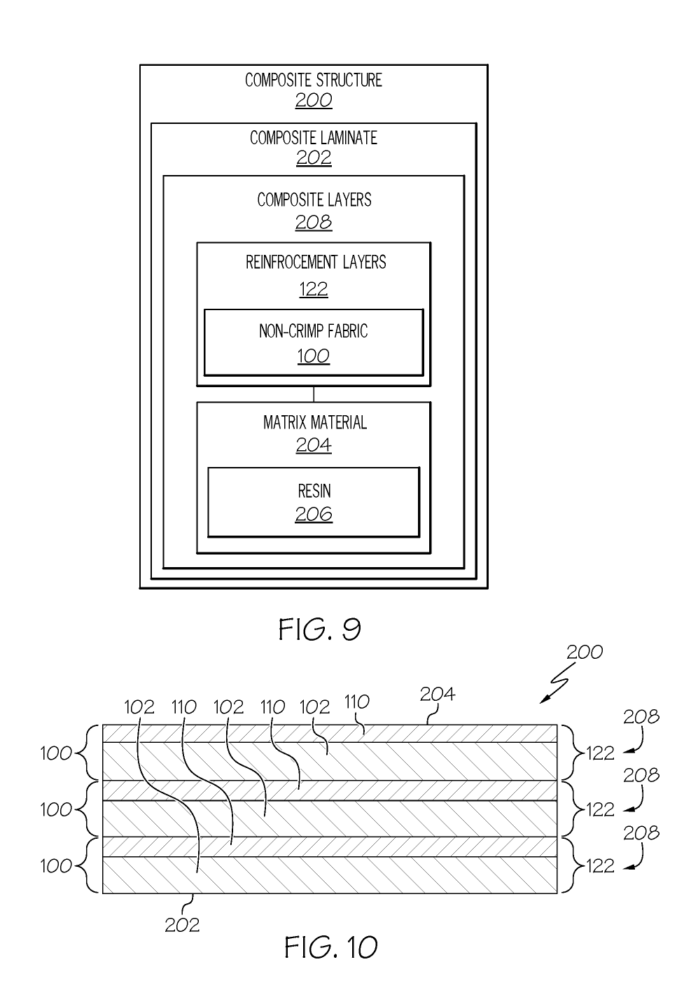

The reinforcing tows 106 of the superimposed non-crimp layers 104 form an angle relative to each other when viewed perpendicular to the layer plane. The orientation or direction of the tows 106 forming each of the non-crimp layers 104 alternates in several different directions to produce the multiaxial non-crimp layup 102, for example, having optimum strength and stiffness in one or more of the different directions. By this configuration it is possible to carry out an adaptation of the direction of the reinforcing tows 106 with respect to the directions of stress in a subsequent composite structure or component, for example, the composite structure 200 (FIG. 9), and to ensure the required strengths in these directions of stress.

In the illustrative embodiment, the non-crimp layers 104 are superimposed such that the reinforcing tows 106 of the non-crimp layers 104 are oriented parallel to each other or alternately crosswise. When the non-crimp layers 104 of reinforcing tows 106 alternate at defined angles with respect to the zero-degree direction, a symmetrical or quasi-isotropic structure results. The numbers of non-crimp layers 104 and the layup angles are virtually infinitely adjustable. Typically, for multiaxial non-crimp fabrics 122, angles of 0°, 90°, plus or minus 20°, plus or minus 25°, plus or minus 30°, plus or minus 45°, plus or minus 60°, or plus or minus 80° are set and the structure is selected such that a symmetrical structure with respect to the zero-degree direction results. As illustrated in FIG. 2, in a specific example, the non-crimp layers 104 are multi-axial with the tows 106 of respective non-crimp layers 104A-104E being arranged at angles of 0°, 90°, +45°, 90° and −45°, respectively.

The present disclosure recognizes that arranging the reinforcing tows 106 parallel to each other and abutting parallel together within each non-crimp layer 104 provides high filament volume proportions and avoids zones with low filament proportions, which is advantageous with respect to providing a high level of the mechanical characteristics in the resulting composite structure (e.g., composite structure 200).

In an exemplary embodiment, the reinforcing tows 106 are carbon tows. In other words, the reinforcement material 108 (FIG. 1) is carbon and the continuous filaments 118 (FIG. 1) forming the multifilament reinforcing tows 106 are continuous carbon filaments (e.g., carbon fiber filaments). As used herein, the term “continuous filament” has its ordinary meaning as known to those skilled in the art and may include a long filament, also commonly referred to as an elongated fiber, that extends across substantially the entire length or width of an associated non-crimp layer 104 or the non-crimp layup 102.

In another example embodiment, the reinforcing tows 106 are glass tows, for example, the reinforcement material 108 (FIG. 1) is glass and the continuous filaments 118 (FIG. 1) forming the multifilament tows 106 are continuous glass filaments (e.g., glass fiber filaments). In another example embodiment, the reinforcing tows 106 are aramid tows, for example, the reinforcement material 108 is an aramid and the continuous filaments 118 forming the multifilament tows 106 are continuous aramid filaments (e.g., aramid fiber filaments). In yet another example embodiment, the reinforcing tows 106 are ultra-high-molecular-weight (UHMW) polyethylene tows, for example, the reinforcement material 108 is UHMW polyethylene and the continuous filaments 118 forming the multifilament tows 106 are continuous UHMW polyethylene filaments (e.g., aramid fiber filaments).

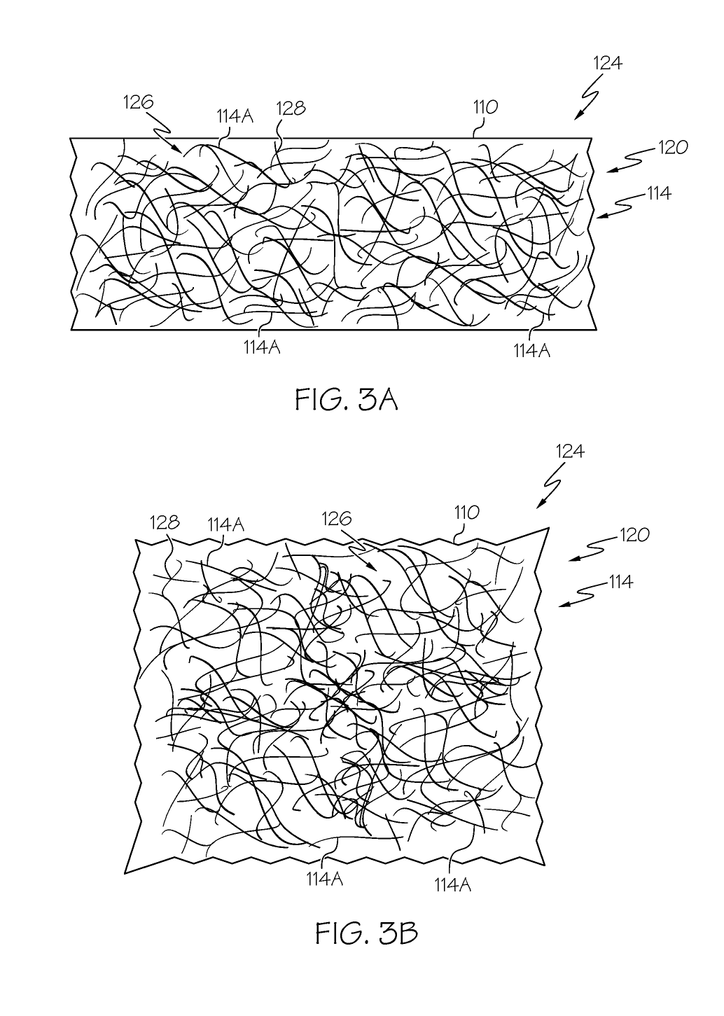

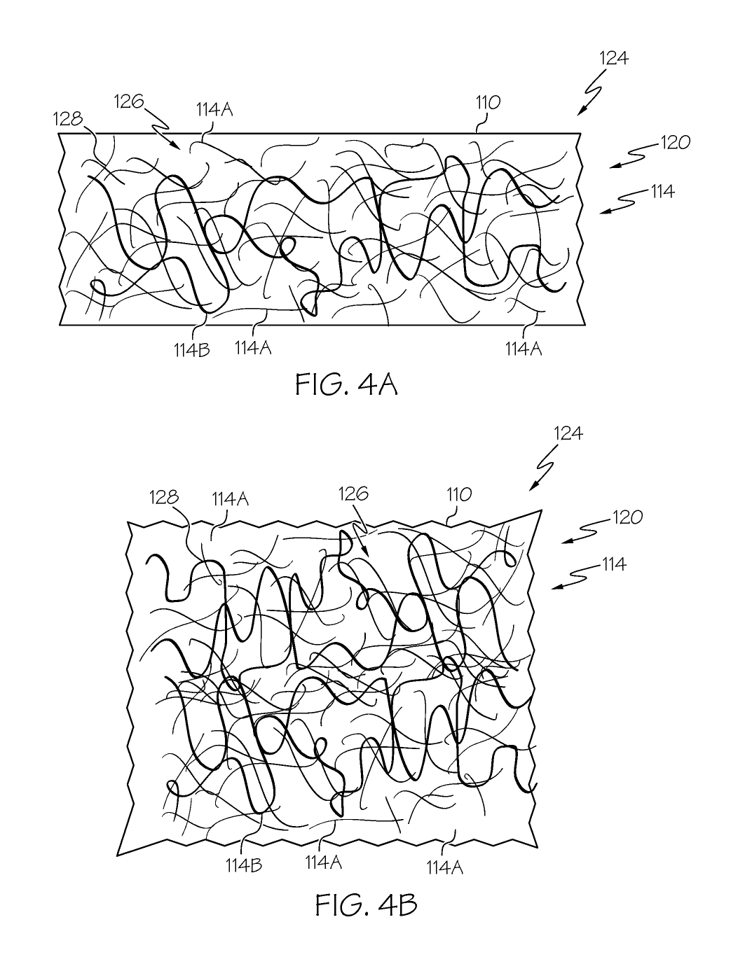

FIG. 3A is a schematic partial cross-sectional view of one embodiment of the nonwoven fabric 124. FIG. 3B is a schematic partial top plan view of the nonwoven fabric 124 of FIG. 3A. FIG. 4A is a schematic partial cross-sectional view of another embodiment of the nonwoven fabric 124. FIG. 4B is a schematic partial top plan view of the nonwoven fabric 124 of FIG. 4A. In the illustrative embodiments, the nonwoven fabric layer 110 includes or is formed by a three-dimensional network or web of intralayer entangled fibers 114, generally referred to herein as a fiber network 120. As used herein, the term “intralayer entangled” has its ordinary meaning as known to those skilled in the art and may include fibers 114 that are mechanically entwined and interlocked with other fibers 114 within the fiber network 120 forming the nonwoven fabric layer 110.

In various embodiments, the nonwoven fabric layer 110 may be implemented as at least one of a nonwoven veil, mat, sheet, tape or some other type of collection of fibers 114 formed with a nonwoven configuration, such as a fabric that is spunbonded, spunlaced or mesh fabric.

In the illustrative embodiment shown in FIGS. 3A and 3B, the fiber network 120 includes or is formed from discontinuous fibers 114A. As used herein, the term “discontinuous fiber” has its ordinary meaning as known to those skilled in the art and may include a relatively short fiber 114 (e.g., thread-like structures) that does not extend across substantially the entire length or width of the nonwoven fabric layer 110. In an example implementation, the discontinuous fibers 114A may have a minimum length substantially equal to the combined thickness T₁ of the non-crimp layup 102 (e.g., the stacked non-crimp layers 104) and thickness T₂ of the nonwoven fabric layer 110 (FIGS. 5 and 6). As an example, the majority (e.g., between approximately 50 percent and approximately 90 percent) of the discontinuous fibers 114A have a length of between approximately 10 mm and 100 mm.

As an example, the fiber network 120 may include a plurality of intermingled and intralayer entangled discontinuous fibers 114A dispersed into a non-woven format. As an example, the intralayer entangled discontinuous fibers 114A are mechanically entwined and interlocked with other discontinuous fibers 114A within the fiber network 120 forming the nonwoven fabric layer 110. As a specific example, the discontinuous fibers 114A may be formed from chopped continuous filaments, such as recycled continuous filaments.

As an example, the discontinuous fibers 114A may include relatively short fibers of at least one of the same sizes, same diameters, same cross-sectional shapes, same types, or some combination thereof. As another example, the discontinuous fibers 114A may include relatively short fibers of at least one of different sizes, different diameters, different cross-sectional shapes, different types, or some combination thereof.

In the illustrative embodiment shown in FIGS. 4A and 4B, the fiber network 120 includes or is formed from discontinuous fibers 114A and continuous fiber 114B. As used herein, the term “continuous fiber” has its ordinary meaning as known to those skilled in the art and may include a relatively long fiber 114 that extends across one of substantially the entire length or width of the nonwoven fabric layer 110. As an example, the continuous fibers 114B may include a length of less than approximately 1 m up to the length of the nonwoven fabric 124.

As an example, the fiber network 120 may include a plurality of intermingled and intralayer entangled discontinuous fibers 114A and continuous fibers 114B dispersed into a non-woven format. As an example, the intralayer entangled continuous fibers 114B are mechanically entwined and interlocked with other continuous fibers 114B and discontinuous fibers 114A within the fiber network 120 forming the nonwoven fabric layer 110. As an example, the continuous fibers 114B may be formed from recycled continuous filaments.

As an example, the continuous fibers 114B may include relatively long fibers of at least one of the same sizes, same diameters, same cross-sectional shapes, same types, or some combination thereof. As another example, the continuous fibers 114B may include relatively long fibers of at least one of different sizes, different diameters, different cross-sectional shapes, different types, or some combination thereof.

In the illustrative embodiments, the fibers 114 (e.g., the discontinuous fibers 114A or the discontinuous fibers 114A and the continuous fibers 114B) have a random orientation relative to each other. However, in other embodiments, the fibers 114 may not be randomly oriented relative to each other.

In the illustrative embodiments, the fiber network 120 also includes openings 126 formed between the fibers 114, for example, the discontinuous fibers 114A of the example configuration shown in FIGS. 3A and 3B and the discontinuous fibers 114A and continuous fibers 114B of the example configuration shown in FIGS. 4A and 4B. In the illustrative embodiments, the density of fibers 114 of the fiber network 120 is sufficiently low such that a porosity of the nonwoven fabric layer 110 is above a selected threshold. The selected threshold may be selected such that the permeability of the nonwoven fabric layer 110, for example, with respect to a resin, is below a selected threshold. As an example, the nonwoven fabric layer 110 may have a density of approximately 20 g/m² at a thickness T₂ of approximately 0.5 mm. As another example, the nonwoven fabric layer 110 may have a density of approximately 400 g/m² at a thickness T₂ of between approximately 2 mm and approximately 10 mm.

As used herein, the term “porosity” has its ordinary meaning as known to those skilled in the art and may include the measure of how much open space is present within the item. For example and without limitation, the open space may be in the form of the openings 126 or voids, gaps, or some other type of open space. As used herein, the term “permeability” has its ordinary meaning as known to those skilled in the art and may include the measure of the ease with which a fluid, such as a resin, can move through the item. Typically, increased porosity results in increased permeability. In an exemplary embodiment, the fiber network 120 may have a permeability sufficiently high to allow resin to permeate, or flow through, the nonwoven fabric layer 110, for example, when a resin system or other matrix material is infused or integrated within non-crimp fabric 100 when making a composite structure, such as the disclosed composite structure 200 (FIG. 9).

In the illustrative embodiments, the fiber network 120 includes a sufficient number of fibers 114 to create a sufficient number of crossover points 128 between intersecting fibers 114 to provide sufficient entanglement of the fibers 114 and hold the fiber network 120 together, thereby forming a stable nonwoven fabric 124 (e.g., nonwoven fabric layer 110). As used herein, the term “stable” has its ordinary meaning as known to those skilled in the art and may include a fiber network 120 that is sufficiently strong, due to the entanglement of the fibers 114, to not fall apart or tear during formation of the disclosed non-crimp fabric 100. The present disclosure recognizes that the use of discontinuous fibers 114A and continuous fiber 114B may increase the stability of the fiber network 120 by providing an increased number of crossover points 128 between the fibers 114 without increasing the density and weight of the nonwoven fabric layer 110.

The fibers 114 (e.g., the discontinuous fibers 114A or the discontinuous fibers 114A and the continuous fibers 114B) of the fiber network 120 forming the nonwoven fabric layer 110 are made of fiber material 116 (FIG. 1). In an example embodiment, the fiber material 116 of the discontinuous fibers 114A and/or the continuous fibers 114B is the same. In such an example embodiment, the fiber network 120 forms a homogeneous nonwoven fabric layer 110. In another example, the fiber material 116 of the discontinuous fibers 114A and the continuous fibers 114B is different. In such an example embodiment, the fiber network 120 forms a heterogeneous nonwoven fabric layer 110.

In an example embodiment, the fiber material 116 of the fibers 114 (e.g., the discontinuous fibers 114A or the discontinuous fibers 114A and the continuous fibers 114B) of the fiber network 120 forming the nonwoven fabric layer 110 of the nonwoven fabric 124 and the reinforcement material 108 (FIG. 1) of the reinforcing tows 106 (e.g., the continuous filaments 118) forming the non-crimp layers 104 of the non-crimp layup 102 (FIG. 1) are the same. In such an example embodiment, the non-crimp layup 102 (e.g., the non-crimp layers 104) and the nonwoven fabric 124 (e.g., the nonwoven fabric layer 110) form a homogeneous non-crimp fabric 100.

As such, in an exemplary embodiment, the fiber material 116 is carbon. In other words, the fibers 114 (e.g., the discontinuous fibers 114A or the discontinuous fibers 114A and the continuous fibers 114B) are carbon fibers. In another embodiment, the fiber material 116 is glass, for example, the fibers 114 (e.g., the discontinuous fibers 114A or the discontinuous fibers 114A and the continuous fibers 114B) are glass fibers. In another embodiment, the fiber material 116 is an aramid, for example, the fibers 114 (e.g., the discontinuous fibers 114A or the discontinuous fibers 114A and the continuous fibers 114B) are aramid fibers. In yet another embodiment, the fiber material 116 is UHMW polyethylene, for example, the fibers 114 (e.g., the discontinuous fibers 114A or the discontinuous fibers 114A and the continuous fibers 114B) are UHMW polyethylene fibers.

In another example embodiment, the fiber material 116 of the fibers 114 (e.g., the discontinuous fibers 114A or the discontinuous fibers 114A and the continuous fibers 114B) and the reinforcement material 108 of the reinforcing tows 106 are different. In such an example embodiment, the non-crimp layup 102 and the nonwoven fabric 124 form a heterogeneous non-crimp fabric 100.

As examples, the fiber material 116 may include at least one of silica (e.g., silica fibers), polyamide (e.g., polyamide fibers), polyether ketone (PEK) (e.g., PEK fibers), polyester (e.g., polyester fibers), polyether sulfone (PES) (e.g., PES fibers), polyimide (e.g., polyimide fibers), polyurethane (e.g., polyurethane fibers) or other types of fibers.

The fiber network 120 forming the nonwoven fabric layer 110 may include individual strands of fiber material 116 (e.g., individual fibers 114) and/or bundles of strands of fiber material 116 (e.g., bundles of fibers 114). In an exemplary embodiment of the fiber network 120, the fibers 114 (e.g., strands of fiber material 116 or bundles of fiber material 116) are sufficiently intermingled and entwined, have a sufficient number of crossover points 128 and/or have sufficient entanglement to produce a stable nonwoven fabric layer 110 without the need for a binder or other additional additive. Alternatively, in another example embodiment, the fiber network 120 may include an additional binder (not explicitly illustrated), such as dry thermoplastic fibers or powder or wet polymer solutions or emulsions, applied to the fibers 114 to produce the nonwoven fabric layer 110. In this example embodiment, the additional binder may add further features or material characteristics to the nonwoven fabric layer 110, such as pre-compaction of the nonwoven fabric layer 110, for example, following heat treatment.

FIG. 5 is a schematic partial cross-sectional view of one embodiment of the disclosed non-crimp fabric 100. In the illustrative embodiment, the nonwoven fabric layer 110 is positioned or disposed in contact with the outermost (e.g., top or bottom) non-crimp layer 112 of the non-crimp layup 102. At least of portion of the fibers 114 (e.g., discontinuous fibers 114A or discontinuous fibers 114A and continuous fibers 114B) (FIG. 1) extend at least partially though the thickness T of the non-crimp layup 102. The fibers 114 of the nonwoven fabric layer 110 integrate themselves within one or more non-crimp layers 104 of the non-crimp layup 102 in order to hold the non-crimp layers 104 together and to hold the nonwoven fabric layer 110 and the non-crimp layup 102 together. The fibers 114 are intermingled and are interlayer entangled with the reinforcing tows 106. As used herein, the term “interlayer entangled” has its ordinary meaning as known to those skilled in the art and may include may include fibers 114 (e.g., discontinuous fibers 114A or discontinuous fibers 114A and continuous fibers 114B) that are mechanically entwined and interlocked with the continuous filaments 118 of the reinforcing tows 106 forming the non-crimp fabric 100. In other words, the nonwoven fabric 124 serves as the holding material to hold the layers of the multiaxial non-crimp layup 102 together without the use of polymer stitches or a binding material.

In the illustrative example, tufts 130 of fibers 114 extend from the nonwoven fabric layer 110 through the outermost non-crimp layer 112 (e.g., non-crimp layer 104A, as illustrated in FIG. 5) and into one or more of the other non-crimp layers 104 (e.g., non-crimp layers 104B-104E, as illustrated in FIG. 5). Each tuft 130 may include any number of fibers 114. The fibers 114 of the nonwoven fabric layer 110 intermingle and entangle with the tows 106 (e.g., the continuous filaments 118) (FIG. 1) of each non-crimp layer 104 of the non-crimp layup 102 in order to hold the non-crimp layers 104 together and to hold the nonwoven fabric layer 110 and the non-crimp layup 102 together.

Therefore, the superimposed non-crimp layers 104 are connected and secured to each other via a plurality of the tufts 130 of fibers 114 running through the thickness T of the non-crimp layup 102, such that the tows 106 (e.g., the continuous filaments 1118) remain straight and without a substantial crimp and the (e.g., unidirectional or multiaxial) non-crimp fabric 100 is stabilized.

FIG. 6 is a schematic partial cross-sectional view of another embodiment of the disclosed non-crimp fabric 100. In the illustrative embodiment, the nonwoven fabric layer 110 is positioned or disposed in contact with both of the outermost (e.g., top and bottom) non-crimp layers 112 of the non-crimp layup 102 (e.g., non-crimp layer 104A and non-crimp layer 104E, as illustrated in FIG. 6). At least of portion of the fibers 114 (e.g., discontinuous fibers 114A or discontinuous fibers 114A and continuous fibers 114B), such as in the form of tufts 130 of fibers 114, from each one of the nonwoven fabric layers 110 extend at least partially though the thickness T of the non-crimp layup 102. The fibers 114 of the nonwoven fabric layers 110 integrate themselves within one or more non-crimp layers 104 of the non-crimp layup 102 in order to hold the non-crimp layers 104 together and to hold the nonwoven fabric layers 110 and the non-crimp layup 102 together.

In an exemplary embodiment, the density of fibers 114 forming the fiber network 120 of the nonwoven fabric layer 110 is sufficient to achieve an optimum number of fibers 114 extending through and entangling with the non-crimp layers 104.

In an exemplary embodiment, the density of fibers 114 forming the fiber network 120 in the nonwoven fabric layer 110 is lower than the density of continuous filaments 118 of the reinforcing tows 106 forming the non-crimp layers 104.

In various example embodiments, the ratio by weight of the nonwoven fabric layer 110 to the non-crimp layers 104 (e.g., fibers 114 to filaments 118) may vary widely, for example, depending upon the configuration of the nonwoven fabric layer 110 and/or the one or more non-crimp layers 104, the intended use of the disclosed non-crimp fabric 100, for example, as a dry preform or a wet preform and the like. In an exemplary implementation, the ratio by weight of the nonwoven fabric layer 110 to the non-crimp layers 104 may be approximately 70:30. As an example configuration of this implementation, the non-crimp fabric 100 may includes one unidirectional non-crimp layer 104. In another exemplary implementation, the ratio by weight of the nonwoven fabric layer 110 to the non-crimp layers 104 may be approximately 30:70. As an example configuration of this implementation, the non-crimp fabric 100 includes a plurality of multiaxial non-crimp layers 104. In another example implementation, the ratio by weight of the nonwoven fabric layer 110 to the non-crimp layers 104 may be between approximately 25:75 and approximately 75:25. In yet another example implementation, the ratio by weight of the nonwoven fabric layer 110 to the non-crimp layers 104 may be as much as approximately 5:95 to approximately 95:5.

In an exemplary embodiment, the portion of the fibers 114 (e.g., discontinuous fibers 114A or discontinuous fibers 114A and continuous fibers 114B) that extend, that penetrate and/or that are integrated at least partially through the non-crimp layup 102 may be between approximately 1 percent and approximately 25 percent of the fibers 114 forming the nonwoven fabric layer 110.

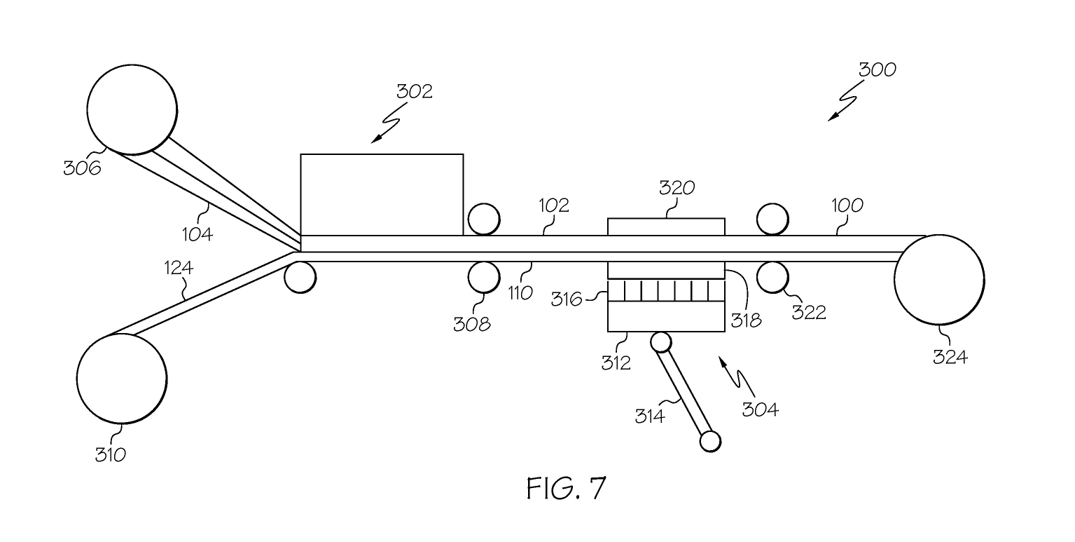

FIG. 7 is a schematic illustration of one embodiment of the disclosed apparatus 300 for making the disclosed non-crimp fabric 100. In the illustrative embodiment, the apparatus 300 includes a lay-up device 302 configured to form the non-crimp layup 102. The apparatus 300 also includes a needle punch device 304 configured to embed the fibers 114 (FIG. 1) of the nonwoven fabric 124 through the non-crimp layup 102.

The lay-up device 302 is configured to construct the non-crimp layup 102 by forming each one of the non-crimp layers 104 from reinforcing tows 106 and superimposing the non-crimp layer 104 at defined angles with respect to the zero-degree direction to form the non-crimp layup 102. As an example, the reinforcing tows 106 may be provided to the lay-up device 302. As an example, the tows 106 may be drawn from a tow supply reel 306 or take-off roll. The lay-up device 302 positions the tows 106 within the non-crimp layers 104 with respect to each other such that they are substantially parallel to each other and abut each other, essentially adjacent to each other without any substantial gaps. The lay-up device 302 provides for X-axis and Y-axis orientation of the tows 106 in order to form a multiaxial non-crimp layup 102.

In an example implementation, each one of the non-crimp layers 104 of the non-crimp layup 102 may be successively placed on and supported by the nonwoven fabric 124 forming the nonwoven fabric layer 110. In another example implementation, the non-crimp layup 102 may be completely formed and placed on the nonwoven fabric layer 110. Once the lay-up device 302 forms the non-crimp layup 102, the apparatus 300 is configured to superimpose the nonwoven fabric 124 and the non-crimp layup 102. As an example, one or more guide rollers 308 positions the nonwoven fabric layer 110 into surface contact with the non-crimp layup 102. As an example, the nonwoven fabric 124 may be drawn from a nonwoven fabric supply reel 310 or take-off roll.

The nonwoven fabric 124 may be introduced to the non-crimp layup 102 in an unconsolidated state or in a partially consolidated state. As used herein, the term “unconsolidated” has its ordinary meaning as known to those skilled in the art and may include the nonwoven fabric 124 being in a fluffy or uncompressed condition or form, for example, having a density of approximately 400 g/m² with a thickness of approximately 10 mm. As used herein, the term “consolidated” has its ordinary meaning as known to those skilled in the art and may include the nonwoven fabric 124 being in a compressed condition or form, for example, having a density of approximately 400 g/m² with a thickness of approximately 2 mm. As used herein, the term “partially consolidated” has its ordinary meaning as known to those skilled in the art and may include the nonwoven fabric 124 being compressed, but not compressed into a final consolidated form. Consolidation may be achieved by some combination of heat and/or pressure.

The superimposed nonwoven fabric layer 110 and non-crimp layup 102 is then passed to the needle punch device 304. The needle punch device 304 may also be referred to as a needle loom. The needle punch device 304 includes a needle board 312, configured to be reciprocated vertically (e.g., moves up and down) by any suitable reciprocating mechanism 314 (e.g., a crankshaft). The needle board 312 includes or carries a plurality of coarse gauge barbed needles 316.

The barbed needles 316 are passed or driven through aligned holes in a plate 318, through the superimposed nonwoven fabric layer 110 and non-crimp layup 102 (e.g., the plurality of non-crimp layers 104), and through aligned holes in a bed plate 320, and are then withdrawn. During passage of the barbed needles 316 through the nonwoven fabric layer 110, the barbs engage certain ones of the fibers 114 of the nonwoven fabric layer 110 and carry them at least partially or substantially entirely through the non-crimp layup 102 where they entangle and intermingle with the tows 106 (e.g., the continuous filaments 118) of one or more of the non-crimp layers 104. When the barbed needles 316 are withdrawn, the fibers 114 are released from the barbs and remain as the tufts 130 of fibers 114 penetrated through the non-crimp layup 102 and intermingled and interlayer entangled with the reinforcing tows 106 to form the non-crimp fabric 100. The needle punch device 304 may partially consolidate the nonwoven fabric layer 110.

Those skilled in the art will appreciate that the size, or gauge, of the barbed needles 316 may be determined and/or selected according to various material and/or process parameters and/or needs, such as the size (e.g., cross-sectional dimension or diameter) of the fibers 114, the size (e.g., cross-sectional dimension or diameter) of the filaments 118, the friction produced between the needles 316 and the fibers 114 and filaments 118, the processing speed of the superimposed nonwoven fabric layer 110 and non-crimp layup 102 through the needle punch device 304, the processing speed of the needle board 312 through the superimposed nonwoven fabric layer 110 and non-crimp layup 102, the overall thickness of the superimposed nonwoven fabric layer 110 and non-crimp layup 102 (e.g., the combined thickness T₁ and T₂) (FIGS. 5 and 6).

Following integration of the nonwoven fabric layer 110 and the non-crimp layup 102 by the needle punch device 304, the non-crimp fabric 100 is passed through at least one pair of pressure rollers 322 to completely consolidate the nonwoven fabric layer 110 and compress (e.g., calender) the non-crimp fabric 100 to a final thickness, for example, approximately 0.2 mm.

The final non-crimp fabric 100 may then be stored on a non-crimp fabric reel 324 or take-in roll.

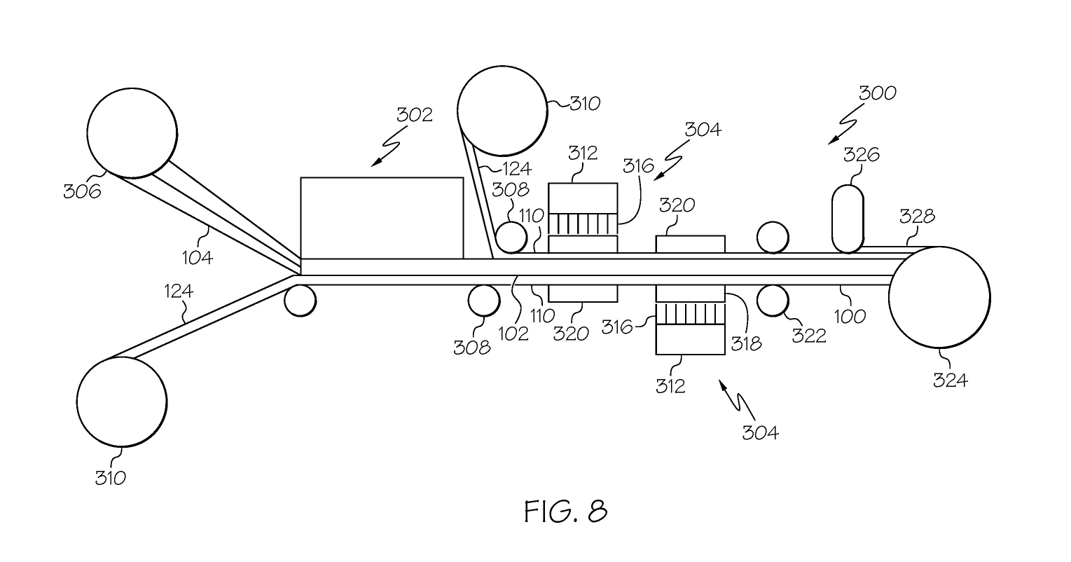

FIG. 8 is a schematic illustration of another embodiment of the disclosed apparatus 300 for making the disclosed non-crimp fabric 100. In the illustrative embodiment, the apparatus 300 includes the lay-up device 302 configured to form the non-crimp layup 102 and a pair of needle punch devices 304 configured to embed the fibers 114 (FIG. 1) of two nonwoven fabrics 124 through the non-crimp layup 102.

Once the lay-up device 302 forms the non-crimp layup 102, the apparatus 300 is configured to superimpose two nonwoven fabrics 124 and the non-crimp layup 102. As an example, one or more guide rollers 308 positions two nonwoven fabric layers 110 into opposing surface contact with the non-crimp layup 102.

The superimposed nonwoven fabric layers 110 and non-crimp layup 102 is then consecutively passed to the needle punch devices 304 where the barbed needles 316 pass through the nonwoven fabric layer 110, engage certain ones of the fibers 114 of an associated one of the nonwoven fabric layers 110 and carry them at least partially or substantially entirely through the non-crimp layup 102 where they entangle and intermingle with the tows 106 (e.g., the continuous filaments 118) of one or more of the non-crimp layers 104.

In the illustrative embodiment, the apparatus 300 may also include a spreading device 326 configured to spread a binding material 328 over at least one surface of the non-crimp fabric 100. The binding material 328 may be used to bind multiple layers of non-crimp fabric 100 together, for example, when making the disclosed composite structure 200.

The resulting non-crimp fabric 100 may be used to make structural components, such as a composite structure 200 (FIGS. 9 and 10).

FIG. 9 is a schematic block diagram of one embodiment of the disclosed composite structure 200. FIG. 10 is a schematic cross-sectional view of another embodiment of the disclosed composite structure 200. In the illustrative embodiment, the composite structure 200 takes the form of a composite laminate 202. The composite laminate 202 includes or is formed of one or more composite layers 208, also referred to as plies or lamina. The composite layers 208 (e.g., each one of the composite layers 208) include or are formed of one or more reinforcement layers 122 and a matrix material 204. The reinforcement layers 122 (e.g., each one of the reinforcement layers 122) include or are formed of one or more layers of the non-crimp fabric 100. As also illustrated in FIG. 1, the non-crimp fabric 100 includes or is formed of the nonwoven fabric layer 110 integrated through the non-crimp layup 102 of one or more non-crimp layers 104.

Referring to FIGS. 9 and 10, and with reference to FIGS. 1-6, as such, in the illustrative embodiments, the composite structure 200 (FIGS. 9 and 10) includes or is formed from the non-crimp fabric 100 (e.g., FIGS. 1, 5 and 6), which is formed from the nonwoven fabric layer 110 (e.g., FIGS. 3A, 3B, 4A and 4C) integrated through the non-crimp layup 102 (e.g., FIGS. 1 and 2) to stabilize and hold the non-crimp fabric 100 together, which is then integrated or infused with the matrix material 204. As described herein above, the non-crimp fabric 100 takes the form of the non-crimp layup 102 held together by the integrated nonwoven fabric layer 110. The non-crimp layup 102 may be formed of the non-crimp layers 104 formed of the tows 106 (e.g., FIGS. 1 and 2). The nonwoven fabric layer 110 may take the form of the nonwoven fabric 124 formed of fibers 114 (e.g., FIGS. 3A, 3B, 4A and 4C). The non-crimp layers 104 of the non-crimp fabric 100 may be oriented in a single direction to make the composite layers 208 unidirectional or in two or more directions to make the composite layers 208 multi-axial.

Referring to FIG. 9, as an example, the matrix material 204 may take the form of a resin 206. As used herein the terms “matrix material” and “resin” have their ordinary meaning as known to those skilled in the art and may refer to the resin composition or resin system in the structural composite layer 208, and, optionally, may include minor amounts of additives.

The resin 206 may include at least one polymer. As examples, the resin 206 may be a polymeric resin including at least one of a thermosetting polymer, a thermoplastic polymer, or some other type of polymer, an epoxy-based resin and the like. Optionally, the matrix material 204 may also toughened by adding particles of a thermoplastic material to the resin 206.

Referring to FIGS. 9 and 10, during production of the composite structure 200, one or more layers of the non-crimp fabric 100, used as the reinforcement layers 122, may be cut to shape and draped over a pre-form tool (not explicitly illustrated) to produce a three-dimensional shape of the composite structure 200. Thus, the non-crimp fabric 100 may also be referred to as a preform.

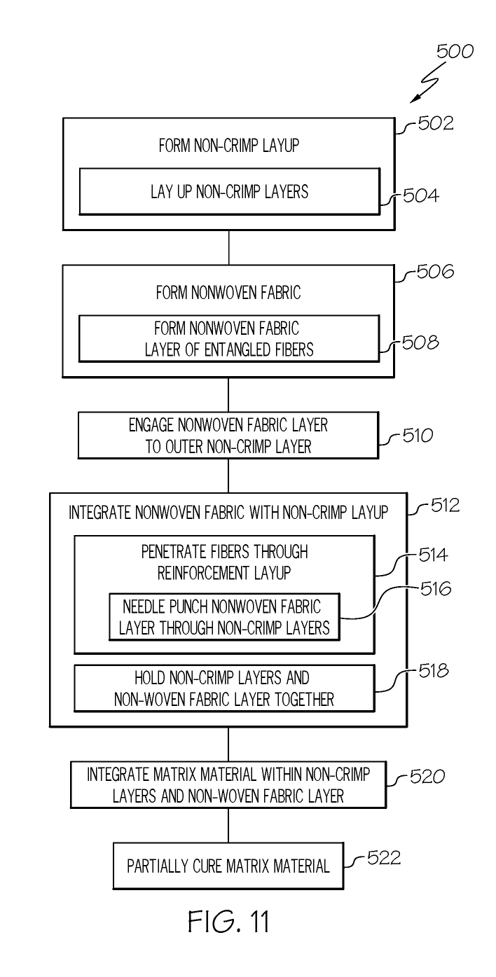

In an example implementation of production of the composite structure 200, the disclosed non-crimp fabric 100, for example, made using the apparatus 300 (FIGS. 7 and 8) in accordance with the disclosed method 500 (FIG. 11), is a dry preform, i.e., with no matrix material 204 present. One or more layers of the dry preform (e.g., the non-crimp fabric 100 used as the reinforcement layers 122) are laid up to form the desired (e.g., three-dimensional) shape of the composite structure 200. The composite structure 200 is then formed by integrating or infusing the matrix material 204 within and through the laid up (e.g., stacked) dry preforms and fully curing matrix material 204.

In another example implementation of production of the composite structure 200, following formation of the disclosed non-crimp fabric 100, for example, made using the apparatus 300 (FIGS. 7 and 8) in accordance with the disclosed method 500 (FIG. 11), the non-crimp fabric 100 may be subsequently partially integrated or infused with the matrix material 204 and partially cured to become a wet preform, also known as a prepreg. One or more layers of the wet preform (e.g., the non-crimp fabric 100 used as the reinforcement layers 122 infused with the matrix material 204) are laid up to form the desired (e.g., three-dimensional) shape of the composite structure 200. The composite structure 200 is then formed by fully curing the matrix material 204 of the laid up (e.g., stacked) wet preforms.

As used herein, the terms “integrating,” “infusing,” “integrated,” “infused” and similar terms have their ordinary meaning as known to those skilled in the art and may include causing the matrix material 204 (e.g., the resin 206) to be located within the reinforcement layer 112 (e.g., the non-crimp fabric 100). This integration may be performed by, for example and without limitation, infusing the non-crimp fabric 100 with the resin 206, injecting the resin 206 into non-crimp fabric 100, saturating the non-crimp fabric 100 with the resin 206, mixing the resin 206 with the non-crimp fabric 100, impregnating the non-crimp fabric 100 with the resin 206, or some combination thereof.

The composite structure 200 may then be left uncured, partially cured, or fully cured, depending on the implementation. This composite structure 200 may be referred to as an integrated preform. When left uncured, the composite structure 200 may be referred to as an integrated preform or an uncured composite structure. The integrated preform may be partially cured to take the form of a partially cured composite structure. This partial curing may be performed to allow easier transport and handling of the composite structure. The integrated preform may be fully cured to take the form of a fully cured composite structure. A carbon fiber-reinforced polymer (CFRP) laminate is an example of one type of the composite laminate 202.

FIG. 11 is a flow diagram of one embodiment of the disclosed method 500 for making a non-crimp fabric, for example, to be used in production of a composite structure. The method 500 illustrated in FIG. 11 may be implemented to form the disclosed non-crimp fabric 100 (FIG. 1), which may be used to make the disclosed composite structure 200 (FIG. 9).

As shown at block 502, the non-crimp layup 102 is formed. As shown at block 504, the non-crimp layup 102 is formed by laying up the non-crimp layers 104. As used herein, the terms “layup” and “laying up” have their ordinary meaning as known to those skilled in the art and may include one or more non-crimp layers 104 that are placed adjacent one another. Each of the non-crimp layers 104 is formed of tows 106 arranged parallel to each other.

As shown at block 506, the nonwoven fabric 124 is formed. As shown at block 508, the nonwoven fabric 124 is formed by forming a nonwoven fabric layer 110 of intralayer entangled fibers 114.

As shown at block 510, the nonwoven fabric layer 110 is engaged to the outer non-crimp layer 112 of the non-crimp layup 102.

As shown at block 512, the non-crimp layup 102 and the nonwoven fabric 124 are integrated to hold the non-crimp layup 102 and the nonwoven fabric 124 (e.g., non-crimp fabric 100) together in order to make the non-crimp fabric 100. As shown at block 514, at least a portion of the fibers 114 (e.g., the intralayer entangled fibers 114) are penetrated at least partially through the non-crimp layup 102. As shown at block 516, the nonwoven fabric layer 110 is needle punched through the non-crimp layers 104 to penetrate the fibers 114 through the non-crimp layup 102. As shown at block 518, the one or more non-crimp layers 104 and the nonwoven fabric layer 110 are held together by the fibers 114 extending through the non-crimp layup 102. At least a portion of the intralayer entangled fibers 114 of the nonwoven fabric layer 110 are interlayer entangled with the tows 118 of the one or more non-crimp layers 104 to hold the non-crimp layers 104 and the nonwoven fabric layer 110 together and form the non-crimp fabric 100.

As discussed above, the preceding steps of the disclosed method 500 illustrated by example in blocks 502, 504, 508, 510, 512, 514, 516 and 518 may produce the non-crimp fabric 100 free of the matrix material 204, otherwise known as the dry preform, which may then be used to produce the disclosed composite structure 200 (FIGS. 9 and 10).

Optionally, the disclosed method 500 may include additional steps to produce the non-crimp fabric 100 that is pre-impregnated with the matrix material 204, otherwise known as the wet preform or pregreg. As such in an example embodiment, the method 500 may be implemented to make a pre-impregnated non-crimp fabric 100, which may then be used to make the disclosed composite structure 200 (FIGS. 9 and 10).

As shown at block 520, the matrix material 204 is at least partially integrated or infused through the one or more non-crimp layers 104 (e.g., the non-crimp layup 102) and the nonwoven fabric layer 110 held together by the intralayer entangled fibers 114 of the nonwoven fabric layer 110 being interlayer entangled with the tows 118 of the one or more non-crimp layers 104. As shown at block 522, the matrix material 204 is partially cured to make the pre-impregnated non-crimp fabric 100.

In an exemplary implementation of the disclosed method 500, the manufacturing apparatus 300 (FIGS. 7 and 8) may be used to make the non-crimp fabric 100.

Based on its specific structure, the disclosed non-crimp fabric 100 distinguishes itself by a good drapability and fixability of the non-crimp layers 104 in the preform, by a good permeability during the infiltration with the matrix material 204 and good surface finish of the composite structure 200. The nonwoven fabric layer 110 also provides additional thickness to the non-crimp fabric 100 without increasing cost. In addition, the non-crimp fabric 100 enables the production of composite structures 200 with high mechanical strengths, high stability against compression loading and high tolerance to impact loading. The disclosed non-crimp fabric 100 is therefore especially suitable for the production of preforms, from which more complex fiber composite components are produced.

Advantageously, the nonwoven fabric layer 110 stabilizes the non-crimp layup 102 by holding the non-crimp layers 104 together in a substantially crimp-free construction, while maintaining the orientation or direction of the tows 106 forming each non-crimp layer 104. Thus, the nonwoven fabric layer 110 enables easier handling of the multiaxial non-crimp fabric 100 since the non-crimp layup 102 remains intact. Further, straight, non-crimped tows 106 within a reinforcing fabric allows for very good resin impregnation and wet-out. Further, use of the nonwoven fabric layer 110 to hold the non-crimp layers 104 together and stabilize the non-crimp layup 102 may eliminate the need for stitching or application of a binder and the disadvantages associated with their use. The disclosed non-crimp fabric 100 formed from the nonwoven fabric layer 110 integrated into the non-crimp layers 104 prevents crimping or undulations in the non-crimp layers 104 that can lead to a loss of performance in a finished composite laminate.

Additionally, the non-crimp fabric 100 formed in accordance with the present disclosure may provide an additional cost-effective advantage by utilizing recycled carbon fiber or other reinforcing fibers extracted during the recycling of cured composite parts. The disclosed non-woven fabric layer 110 may be formed of continuous 114A and or discontinuous 114B from a recycled source, which results in a lower cost and environmentally friendly benefit for the non-woven fabric 124 and for the associated non-crimp fabric 100.

Additionally, since the disclosed non-crimp fabric 100 is formed without the use of stitching or a binder to hold the non-crimp layers 104 together, which introduces foreign material, the step of removing such stitching or other foreign material during a subsequent recycling operation is eliminated. As such, in various embodiments of the disclosed non-crimp fabric 100, recycled fibers and/or filaments may be used as the fibers 114 of the nonwoven fabric layer 110.

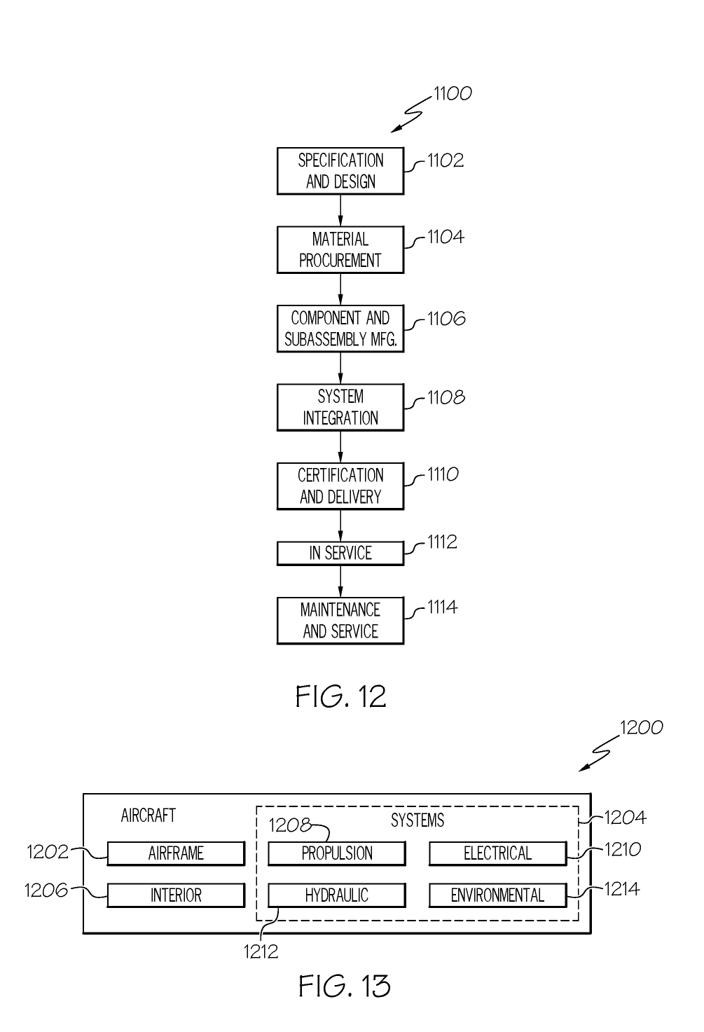

Examples of the disclosed non-crimp fabric 100 and the composite structure 200 made with the non-crimp fabric 100 and the methods for making the same disclosed herein may be described in the context of an aircraft manufacturing and service method 1100 as shown in FIG. 12 and the aircraft 1200 as shown in FIG. 13.

During pre-production, the illustrative method 1100 may include specification and design, as shown at block 1102, of aircraft 1200 and material procurement, as shown at block 1104. During production, component and subassembly manufacturing, as shown at block 1106, and system integration, as shown at block 1108, of the aircraft 1200 may take place. Production of non-crimp fabric 100 and use of non-crimp fabric 100 in the composite structure 200, as described herein, may be accomplished as a portion of the production, component and subassembly manufacturing step (block 1106) and/or as a portion of the system integration (block 1108). Thereafter, the aircraft 1200 may go through certification and delivery, as shown block 1110, to be placed in service, as shown at block 1112. While in service, the aircraft 1200 may be scheduled for routine maintenance and service, as shown at block 1114. Routine maintenance and service may include modification, reconfiguration, refurbishment, etc. of one or more systems of the aircraft 1200.

Each of the processes of illustrative method 1100 may be performed or carried out by a system integrator, a third party, and/or an operator (e.g., a customer). For the purposes of this description, a system integrator may include, without limitation, any number of aircraft manufacturers and major-system subcontractors; a third party may include, without limitation, any number of vendors, subcontractors, and suppliers; and an operator may be an airline, leasing company, military entity, service organization, and so on.

As shown in FIG. 13, the aircraft 1200 produced by the illustrative method 1100 may include an airframe 1202, for example, having composite panels or other composite structures including the non-crimp fabric 100, a plurality of high-level systems 1204 and an interior 1206. Examples of the high-level systems 1204 include one or more of a propulsion system 1208, an electrical system 1210, a hydraulic system 1212 and an environmental system 1214. Any number of other systems may be included. Although an aerospace example is shown, the principles disclosed herein may be applied to other industries, such as the automotive industry, the marine industry, and the like.

The systems, apparatus and methods shown or described herein may be employed during any one or more of the stages of the manufacturing and service method 1100. For example, components or subassemblies corresponding to component and subassembly manufacturing (block 1106) may be fabricated or manufactured in a manner similar to components or subassemblies produced while the aircraft 1200 is in service (block 1112). Also, one or more examples of the systems, apparatus, and methods, or combination thereof may be utilized during production stages (blocks 1108 and 1110). Similarly, one or more examples of the systems, apparatus, and methods, or a combination thereof, may be utilized, for example and without limitation, while the aircraft 1200 is in service (block 1112) and during maintenance and service stage (block 1114).

Reference herein to “embodiment” means that one or more feature, structure, element, component or characteristic described in connection with the embodiment is included in at least one implementation of the disclosed invention. Thus, the phrase “one embodiment,” “another embodiment,” and similar language throughout the present disclosure may, but do not necessarily, refer to the same embodiment. Further, the subject matter characterizing any one embodiment may, but does not necessarily, include the subject matter characterizing any other embodiment.

Similarly, reference herein to “example” means that one or more feature, structure, element, component or characteristic described in connection with the example is included in at least one embodiment. Thus, the phrases “one example,” “another example,” and similar language throughout the present disclosure may, but do not necessarily, refer to the same example. Further, the subject matter characterizing any one example may, but does not necessarily, include the subject matter characterizing any other example.

Unless otherwise indicated, the terms “first,” “second,” etc. are used herein merely as labels, and are not intended to impose ordinal, positional, or hierarchical requirements on the items to which these terms refer. Moreover, reference to a “second” item does not require or preclude the existence of lower-numbered item (e.g., a “first” item) and/or a higher-numbered item (e.g., a “third” item).

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example and without limitation, two of item A, one of item B, and ten of item C; four of item B and seven of item C; or some other suitable combination.

As used herein, the terms “approximately” and “about” represent an amount close to the stated amount that still performs the desired function or achieves the desired result. For example, the terms “approximately” and “about” may refer to an amount that is within less than 10% of, within less than 5% of, within less than 1% of, within less than 0.1% of, and within less than 0.01% of the stated amount.

As used herein, the term “substantially” may include exactly and similar, which is to an extent that it may be perceived as being exact. For illustration purposes only and not as a limiting example, the term “substantially” may be quantified as a variance of +/−5% from the exact or actual. For example, the phrase “A is substantially the same as B” may encompass embodiments where A is exactly the same as B, or where A may be within a variance of +/−5%, for example of a value, of B, or vice versa.

As used herein, the terms “partially” or “at least a portion of” may represent an amount of a whole that includes an amount of the whole that may include the whole. For example, the term “a portion of” may refer to an amount that is greater than 0.01% of, greater than 0.1% of, greater than 1% of, greater than 10% of, greater than 20% of, greater than 30% of, greater than 40% of, greater than 50% of, greater than 60%, greater than 70% of, greater than 80% of, greater than 90% of, greater than 95% of, greater than 99% of, and 100% of the whole.

In FIGS. 1, 9 and 13, referred to above, solid lines, if any, connecting various elements and/or components represent mechanical, electrical, fluid, optical, electromagnetic and other couplings and/or combinations thereof. As used herein, “coupled” means associated directly as well as indirectly. For example, a member A may be directly associated with a member B, or may be indirectly associated therewith, e.g., via another member C. It will be understood that not all relationships among the various disclosed elements are necessarily represented. Accordingly, couplings other than those depicted in the block diagrams may also exist. Dashed lines, if any, connecting blocks designating the various elements and/or components represent couplings similar in function and purpose to those represented by solid lines; however, couplings represented by the dashed lines are either selectively provided or relate to alternative examples of the present disclosure. Likewise, elements and/or components, if any, represented with dashed lines, indicate alternative examples of the present disclosure. One or more elements shown in solid and/or dashed lines may be omitted from a particular example without departing from the scope of the present disclosure. Environmental elements, if any, are represented with dotted lines. Virtual (imaginary) elements may also be shown for clarity. Those skilled in the art will appreciate that some of the features illustrated in FIGS. 1, 9 and 13 may be combined in various ways without the need to include other features described in FIGS. 1, 9 and 13, other drawing figures, and/or the accompanying disclosure, even though such combination or combinations are not explicitly illustrated herein. Similarly, additional features not limited to the examples presented, may be combined with some or all of the features shown and described herein.

In FIGS. 11 and 12, referred to above, the blocks may represent operations and/or portions thereof and lines connecting the various blocks do not imply any particular order or dependency of the operations or portions thereof. Blocks, if any, represented by dashed lines indicate alternative operations and/or portions thereof. Dashed lines, if any, connecting the various blocks represent alternative dependencies of the operations or portions thereof. It will be understood that not all dependencies among the various disclosed operations are necessarily represented. FIGS. 11 and 12 and the accompanying disclosure describing the operations of the disclosed methods set forth herein should not be interpreted as necessarily determining a sequence in which the operations are to be performed. Rather, although one illustrative order is indicated, it is to be understood that the sequence of the operations may be modified when appropriate. Accordingly, modifications, additions and/or omissions may be made to the operations illustrated and certain operations may be performed in a different order or simultaneously. Additionally, those skilled in the art will appreciate that not all operations described need be performed.

Although various embodiments of the disclosed apparatus, systems and methods have been shown and described, modifications may occur to those skilled in the art upon reading the specification. The present application includes such modifications and is limited only by the scope of the claims.

What is claimed is:

1. A non-crimp fabric comprising:
a non-crimp layup of one or more non-crimp layers, each one of said one or more non-crimp layers is formed of tows arranged parallel to each other; and
a nonwoven fabric integrated through said non-crimp layup to hold said one or more non-crimp layers and said nonwoven fabric together.

2. The non-crimp fabric of claim 1 wherein said nonwoven fabric comprises a nonwoven fabric layer engaged to an outer non-crimp layer of said non-crimp layup, said nonwoven fabric layer is formed of fibers, and wherein a portion of said fibers are at least partially integrated through said non-crimp layup to hold said non-crimp layers and said nonwoven fabric layer together.

3. The non-crimp fabric of claim 2 wherein up to 25 percent of said fibers of said nonwoven fabric layer are integrated through said non-crimp layup.

4. The non-crimp fabric of claim 2 wherein said nonwoven fabric further comprises discontinuous fibers intralayer entangled together to form a fiber network, and wherein a portion of said discontinuous fibers extend at least partially through said non-crimp layup and are interlayer entangled with said tows to hold said one or more non-crimp layers and said nonwoven fabric layer together and maintain said tows as substantially non-crimped.

5. The non-crimp fabric of claim 4 wherein said nonwoven fabric further comprises continuous fibers intralayer entangled together with said discontinuous fibers to form said fiber network, and wherein a portion of said continuous fibers extend at least partially through said non-crimp layup and are interlayer entangled with said tows to hold said one or more non-crimp layers and said nonwoven fabric layer together and maintain said tows as substantially non-crimped.

6. The non-crimp fabric of claim 2 wherein said fibers are needle punched through said non-crimp layup.

7. The non-crimp fabric of claim 2 wherein each one of said tows comprises an untwisted bundle of continuous filaments.

8. The non-crimp fabric of claim 7 wherein said filaments comprise a reinforcement material and wherein said fibers comprise a fiber material.

9. The non-crimp fabric of claim 8 wherein:
said reinforcement material comprises one of carbon, glass, aramid and ultra-high-molecular-weight polyethylene, and
said fiber material comprises one of carbon, glass, aramid and ultra-high-molecular-weight polyethylene

10. The non-crimp fabric of claim 2 wherein said nonwoven fabric is between approximately 30 percent and approximately 70 percent by weight of said non-crimp fabric.

11. The non-crimp fabric of claim 2 wherein said non-crimp layup comprises at least said non-crimp layers, and wherein two or more of said non-crimp layers of said non-crimp layup are multi-axial.

12. The non-crimp fabric of claim 1 further comprising a matrix material at least partially infused through said one or more non-crimp layers and said nonwoven fabric.

13. A composite structure comprising:
one or more reinforcement layers of a non-crimp fabric, wherein each of said one or more reinforcement layers of said non-crimp fabric comprises:
a non-crimp layup of one or more non-crimp layers; and
a nonwoven fabric integrated through said non-crimp layup to hold said one or more non-crimp layers and said nonwoven fabric together; and
a matrix material infused through said reinforcement layers.

14. The composite structure of claim 13 wherein:
each one of said non-crimp layers is formed of tows arranged parallel to each other,
said nonwoven fabric comprises a nonwoven fabric layer engaged to an outer non-crimp layer of said non-crimp layup, said nonwoven fabric layer is formed of fibers, and
a portion of said fibers extend at least partially through said non-crimp layup to hold said non-crimp layers and said nonwoven fabric layer together.

15. The composite structure of claim 14 wherein said nonwoven fabric further comprises discontinuous fibers intralayer entangled together to form a fiber network, and wherein a portion of said discontinuous fibers extend at least partially through said non-crimp layup and are interlayer entangled with said tows to hold said one or more non-crimp layers and said nonwoven fabric layer together and maintain said tows as substantially non-crimped.

16. The composite structure of claim 15 wherein said nonwoven fabric further comprises continuous fibers intralayer entangled together and with said discontinuous fibers to form said fiber network, and wherein a portion of said continuous fibers extend at least partially through said non-crimp layup and are interlayer entangled with said tows to hold said one or more non-crimp layers and said nonwoven fabric layer together and maintain said tows as substantially non-crimped.

17. The composite structure of claim 14 wherein said fibers are needle punched through said non-crimp layup.

18. A method for making a non-crimp fabric, said method comprising:
forming a non-crimp layup;
forming a nonwoven fabric; and
integrating said nonwoven fabric with said non-crimp layup to hold said non-crimp layup and said nonwoven fabric together.

19. The method of claim 17 wherein:
forming said non-crimp layup comprises forming one or more non-crimp layers, each of said one or more non-crimp layers is formed of tows arranged parallel to each other, and
forming said nonwoven fabric comprises a forming a nonwoven fabric layer, said nonwoven fabric layer is formed of intralayer entangled fibers.

20. The method of claim 19 further comprising:
engaging said nonwoven fabric layer to an outer non-crimp layer of said non-crimp layup;
penetrating at least a portion of said intralayer entangled fibers at least partially through said non-crimp layup; and
holding said one or more non-crimp layers and said nonwoven fabric layer together, wherein at least a portion of said intralayer entangled fibers are interlayer entangled with said tows.

21. The method of claim 20 wherein penetrating at least a portion of said intralayer entangled fibers at least partially through said non-crimp layup comprises needle punching said nonwoven fabric layer through said non-crimp layers.

22. The method of claim 18 further comprising:
at least partially integrating a matrix material within said one or more non-crimp layers and said nonwoven fabric layer; and
partially curing said matrix material.
